(19) United States
(12) Patent Application Publication
(10) Pub. No.: US 2012/0246955 A1
(43) Pub. Date: Oct. 4, 2012

(54) Bearing adjustment dial gage tool

(75) Inventor: Thomas Smith, Woodstock, IL (US)

(73) Assignee: TRISEAL CORPORATION, Hebron, IL (US)

(21) Appl. No.: 13/065,812

(22) Filed: Mar. 30, 2011

(51) Int. Cl. G01B 7/00

(52) U.S. Cl. 33/517

(57) ABSTRACT

The bearing adjustment dial gage tool comprises a bar which mounts two spaced apart magnets on spindles which extend from the bar and a gage is mounted on the bar with a measuring pin extending from the gage for engaging a wheel hub to measure endplay when the tool is mounted with the two magnets to a wheel assembly.

### BACKGROUND OF THE INVENTION

1. Field of the Invention

The present invention relates to a simple bearing adjustment dial gage tool for measuring the end play in a tractor or trailer wheel end. The tool is a fixture with two magnets which is simpler to use than the prior end play measuring apparatus or tools currently in use.

2. Description of the Prior Art

Heretofore an endplay measuring apparatus was used to measure endplay that included a magnet to attach to the end of the spindle requiring a number of significant setup finesse moves of three joints to bring an indicator against a wheel hub. Such apparatus's are manufactured and sold by Stemco of Longview, Tex. and other companies such as Starrett, Brown and Sharpe, and Mitutoyo.

After bearing adjustment ideal wheel end play is 0.001″ to 0.005 which is controlled by bearing adjustment. The closer to 0.001″, the longer the bearings and seal will last. The end play can be measured with the prior art end play measuring apparatus or the bearing adjustment dial gage tool.

### SUMMARY OF THE INVENTION

The bearing adjustment dial gage tool is comprised of a bar that has two magnets mounted on spacers and a dial indicator. When the tool is attached to the hub with the magnets and the probe on the dial indicator is in contact with the end of the axle, wheel end play can be measured. Using alternate magnet locations the magnets can be attached to the spindle with the indicator probe against the hub to measure end play.

### BRIEF DESCRIPTION OF THE SEVERAL VIEWS OF DRAWINGS

FIG. 1 is a perspective view of the bearing adjustment dial gage tool constructed according to the teachings of the present invention.

FIG. 2 is a perspective view of the bearing adjustment dial gage tool shown in FIG. 1 mounted on the hub of a wheel assembly.

FIG. 3 is an exploded perspective view of the bearing adjustment dial gage tool

### DESCRIPTION OF A PREFERRED EMBODIMENT OF THE PRESENT INVENTION

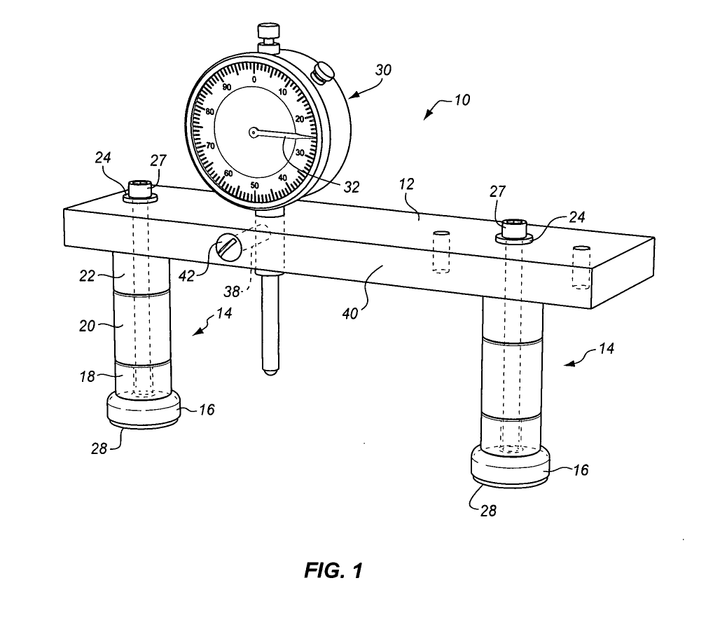

Referring now to the drawings in greater detail, there is illustrated in FIG. 1. a bearing adjustment dial gage tool 10 constructed according to the teachings of the present invention. The tool 10 comprises an elongate bar 12 having a rectangular cross section. Attached to the bar 12 adjacent each end thereof is a spindle assembly 14. The spindle assembly 14 comprises a base portion 16, a first short cylinder 18, an intermediate cylinder 20 and an upper cylinder 22, which are located between the base portion 16 and the bar 12.

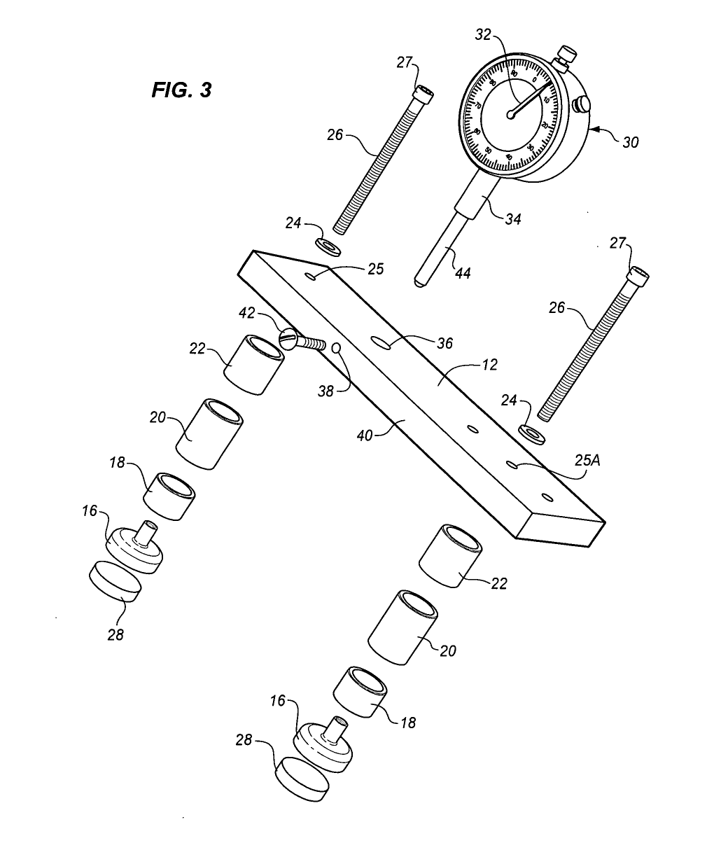

As best shown in FIG. 3 a washer 24, which can be a lock washer, is located above the bar 12, which has a hole 25 or 25a therein. A threaded bolt 26 extends through the washer 24 and the hole 25 or 25a and is threadably received in the top of the base portion 16. The threaded bolt 26 has an Allen screw head for receiving an Allen wrench for tightening the threaded bolt 26 to the base portion 16 and against the elongate bar 12.

A magnet 28 is fixed to the bottom of the base portion 16. A dial gage 30 having a dial indicator 32, has a tubular portion 34, which is received through a hole 36 in the elongate bar 12 and a threaded transverse hole 38 extends into a side 40 of the bar 12 and mates with the hole 36. A screw 42 is threaded into the transverse threaded hole 38 for engaging the tubular portion 34 and locking the dial gage 30 into place.

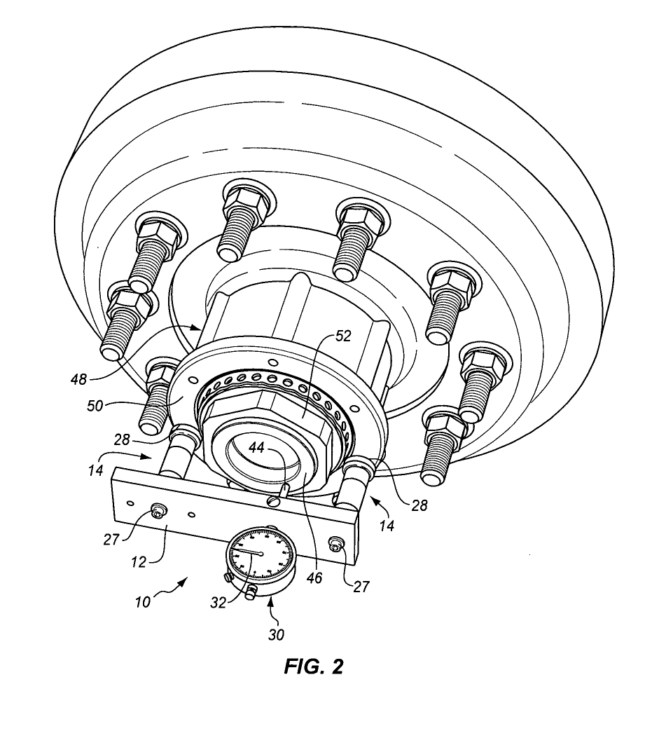

A measuring pin 44 extends from the tubular portion 34 for engaging an outer surface 46 of the spindle for measuring the end play of the wheel hub 48 as shown in FIG. 2.

As shown in FIG. 2, the tool 10 is attached to an outer surface 50 of the wheel hub 48 by the magnets 28.

In using the tool 10, the wheel is pulled outward as far as it will go, then the dial indicator 32 is set at “0” Then a technician pushes the wheel in as far as it will go. Alternately, one can pry the wheel in as far as it will go. Next the technician reads the dial indicator 32, it should read between 0.001″ and 0.005″. If different, the technician readjusts a spindle nut 52 of the wheel hub 48. The closer to 0.001″, the longer the bearings and seal will last. If the bearing end play falls between 0.004″ and 0.005″ the technician may want to readjust the spindle nut 52 of the wheel assembly.

What is claimed is:

1. A bearing adjustment dial gage tool comprising an elongated bar which mounts two spaced apart magnets on spindle assemblies which extend from the bar and a gage is mounted on the bar with a measuring pin extending from the gage for engaging a wheel hub to measure endplay when the tool is mounted with the two magnets on a wheel.

2. The tool of claim 1 wherein each spindle assembly comprise a metal base portion, a magnet mounted on the lower end thereof, a first short cylinder, a second middle cylinder and an upper cylinder a threaded shaft extending through a lock washer, through a hole in the bar and through the cylinders and then is threadably secured to said base portion.

3. The tool of claim 1 wherein said gage includes a depending tubular portion which extends through and is mounted in a throughbore in said bar by a screw extending into a side of said bar and said measuring pin extends from said tubular portion.
